(19) United States
(12) Patent Application Publication
(10) Pub. No.: US 2025/0100114 A1
(43) Pub. Date: Mar. 27, 2025

(54) Torque adjustment tool

(71) Applicant: WEI CHINS PLASTIC ENTERPRISE CORP., Taichung City (TW)

(72) Inventor: Chia-Wei Lai, Taichung City (TW)

(21) Appl. No.: 18/372,058

(22) Filed: Sep. 23, 2023

(51) Int. Cl. B25B 23/142; B25B 23/14

(52) U.S. Cl. CPC B25B 23/1427; B25B 23/141

(57) ABSTRACT

A torque adjustment tool has an inner tube having a front tuning handle on the screw assembly, a spring, an upper toothed block, a lower toothed block, a plurality of balls, a central axis and an adjusting unit. The upper toothed block has a through hole at the center, and there are multiple ball slots arranged in a ring shape on one end surface. The lower toothed block has a polygonal through hole at the center.

### BACKGROUND OF INVENTION

### Field of Invention

The present invention relates to a torque adjustment tool, and more particularly to a torque adjustment tool capable of preventing overload.

### Description of Related Art

Currently, a conventional torque adjustment structure 90, as shown in FIG. 8 and FIG. 9, includes: an inner tube 91, a front fine-tuning rod 92, a spring 93, an upper tooth block 94, a lower tooth block 95, a stopper 96, a compression member 97, a knob 98 and a linking member 99. The inner tube 91 has a cylinder 911 at one end and a polygonal body 912 at the other. The cylinder 911 of the inner tube 91 is provided with an internal screw hole 913, and the cylinder 911 has a fine-tuning fixing hole 914 connected to the inner screw hole 913. The polygonal body 912 is provided with a chamber 915 with an internal screw thread section 916 at its inner wall, and a polygonal through hole 917 is provided between the chamber 915 of the inner tube 91 and the internal screw hole 913. The polygonal body 912 of the inner tube 91 has a sliding slot 918 with a stop screw 919 at its inner wall, and the chute 918 is connected to the chamber 915. The front fine-tuning rod 92 is installed at the front end of the inner tube 91, an external thread section 921 is provided on the outer wall of the front fine-tuning rod 92, and the front fine-tuning rod has a stepped through hole 922. The spring 93 is disposed in the polygonal through hole 917 of the inner tube 91 and the stepped through hole 922 of the front fine-tuning rod 92. The upper tooth block 94 is located in the chamber 915 and the polygonal through hole 917 of the inner tube 91, and the upper tooth block 94 has a polygonal body in corresponding to the polygonal through hole 917 of the inner tube 91. The upper tooth block 94 further has a through hole 941, and one side of the upper tooth block 94 has a plurality of upper teeth 942. One side of the upper tooth 942 is a vertical surface, and the other side is an inclined surface. The lower tooth block 95 is disposed in the chamber 915 of the inner tube 91 and engages with the upper tooth block 94. The lower tooth block 95 has a polygonal through hole 951 and a plurality of lower latching teeth 952, and one side of the lower tooth 952 is a vertical surface, and the other side is a inclined surface. The stopper 96 is installed in the chamber 915 of the inner tube 91 and located on one side of the lower tooth block 95, and the stopper 96 has a through hole 961 and a screw hole 962. The compression member 97 is located at the internal thread section 916 of the chamber 915 of the inner tube 91, and the compression member 97 has a polygonal through hole 971 and an external thread segment 972. The adjusting knob 98 is disposed at the rear end of the inner tube 91 and made of insulating material, and the adjusting knob 98 has a polygonal groove 981 and two inlays 983 opposite each other on the outer surface, and an polygonal groove 984. The linkage member 99 is located in the polygonal groove 984 of the adjustment knob 98, and the linkage member 99 has a polygonal slot 991 at one end and a polygonal connecting rod 992 at the other end.

However, the conventional structure as mentioned above still has the following problems: the upper tooth block 94 and the lower tooth block 95 utilize the upper teeth 942 and the lower tooth 952 for setting torque value, due to the stress-bearing area of the inclined surfaces of the upper latching tooth 942 and the lower latching tooth 952 is smaller, the transmission is less reliable. When the applied force is higher than the set torque value, the upper tooth block 94 and the lower tooth block 95 need to be separated from each other through tooth skipping and become in an idling state, but the friction resistance from the inclined surfaces is relatively large, the upper latching 942 and the lower teeth 952 are difficult to escape, such that the sensitivity of the overload protection is not enough.

Therefore, it is desirable to provide a torque adjustment tool to mitigate and/or obviate the aforementioned problems.

### SUMMARY OF THE INVENTION

An objective of the present invention is to provide a torque adjustment tool capable of preventing overload.

In order to achieve the above mentioned objective, a torque adjustment tool has an inner tube having a front tuning handle on the screw assembly, a spring, an upper toothed block, a lower toothed block, a plurality of balls, a central axis and an adjusting unit. The upper toothed block has a through hole at the center, and there are multiple ball slots arranged in a ring shape on one end surface. The lower toothed block has a polygonal through hole at the center, tooth slots and multiple teeth.

Other objects, advantages, and novel features of invention will become more apparent from the following detailed description when taken in conjunction with the accompanying drawings.

### BRIEF DESCRIPTION OF DRAWINGS

FIG. 1 is the perspective view of a preferred embodiment of the present invention.

FIG. 2 is an exploded view of the preferred embodiment of the present invention.

FIG. 3 is a cross-sectional view of the preferred embodiment of the present invention.

FIG. 4 shows torque adjustment according to the present invention.

FIG. 5 shows a transmission state diagram according to the present invention.

FIG. 6 shows overload protection according to the present invention.

FIG. 7 is a schematic drawing of another preferred embodiment of the present invention.

FIG. 8 is an exploded view of a prior art structure.

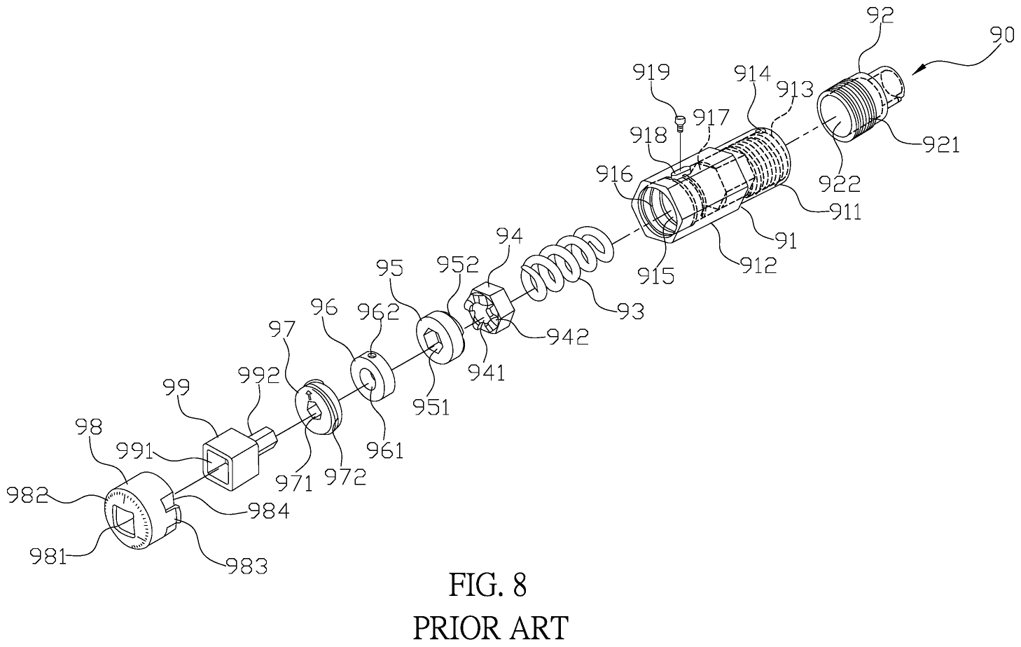

FIG. 9 is a cross-sectional drawing of the prior art structure.

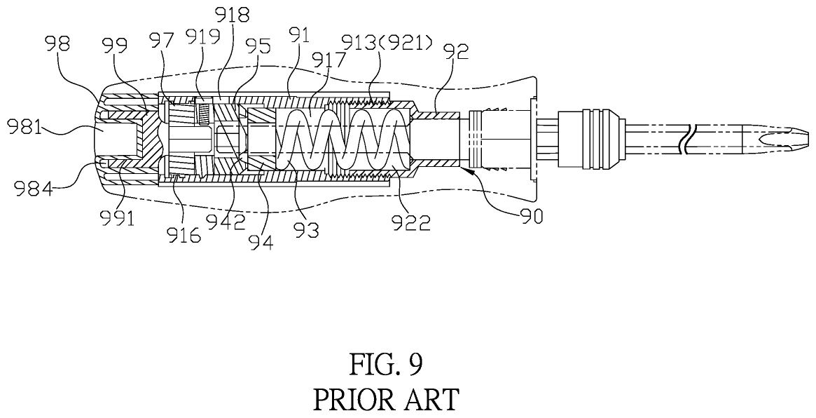

### DESCRIPTION OF THE PREFERRED EMBODIMENT

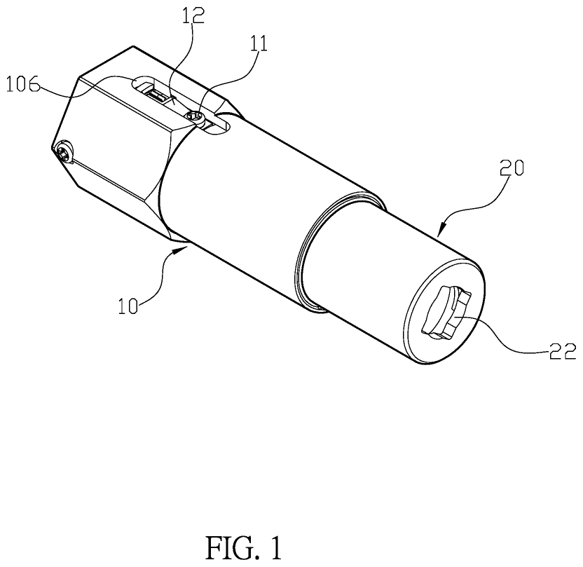

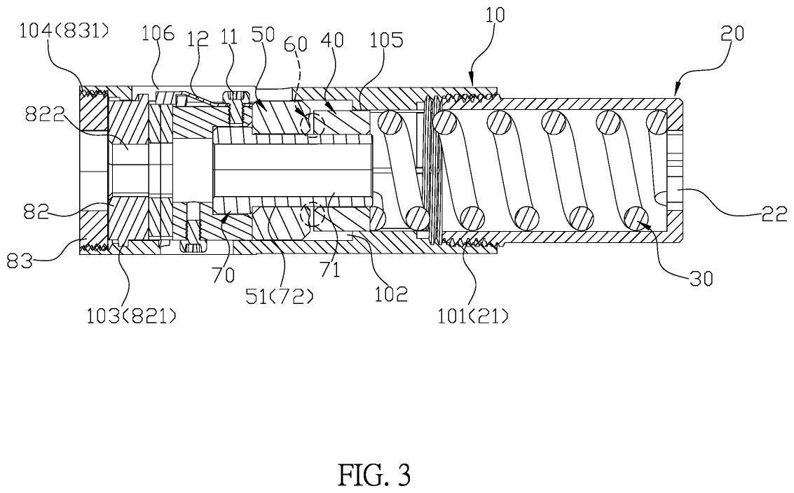

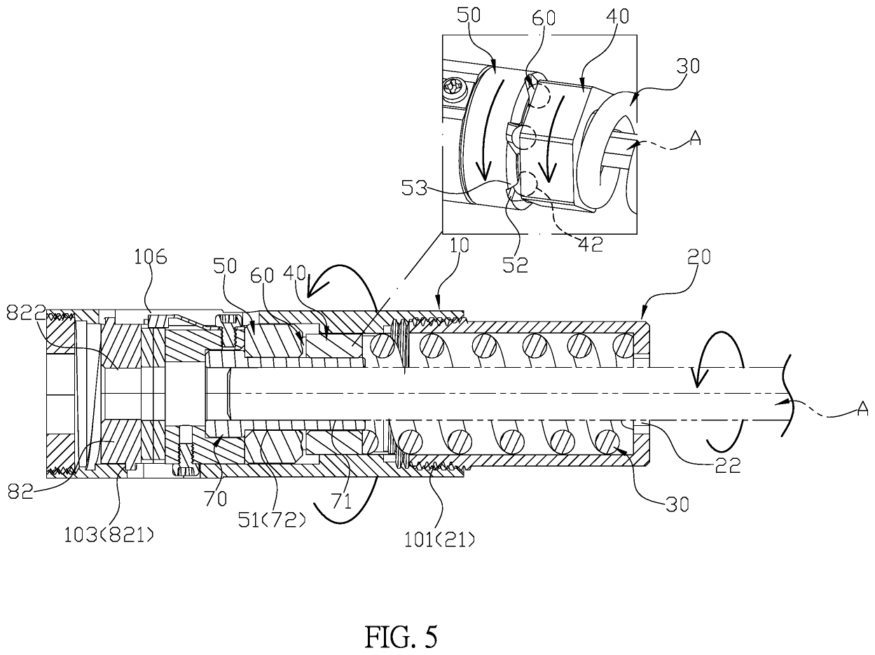

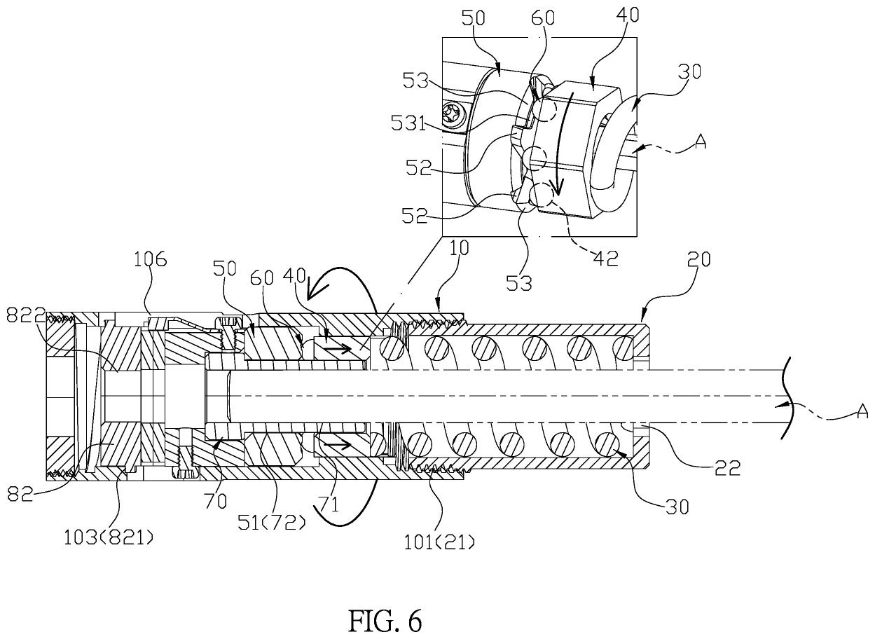

First, please refer to FIG. 1 and FIG. 3. A torque adjustment tool comprises: an inner tube 10, a front tuning handle 20, a spring 30, an upper toothed block 40, a lower toothed block 50, a plurality of balls 60, a central axis 70 and a adjusting unit 80. The inner tube 10 has an inner screw hole 101 at one end and a containing space 102 at another end. A first inner threaded section 103 and a second inner threaded section 104 are provided on a sidewall of the containing space 102. The containing space 102 and the inner screw hole 101 are connected by a polygonal hole 105, and a sidewall of the inner tube 10 has at least one a sliding slot 106 passing through the containing space 102 and having at least one screw 11. The front tuning handle 20 has an open end and a closed end, the open end has an outer threaded section 21 on an outer surface for engaging with the inner screw hole 101 of the inner tube 10, and the closed end has a through aperture 22 for accepting an external tool wrench A for insertion into the inner tube 10. The spring 30 is disposed in the inner tube 10, an end of the spring 30 abutting the closed end of the front tuning handle 20. The upper toothed block 40 has a through hole 41 surrounded by a plurality of ball slots 42. The upper toothed block 40 is disposed in the containing space 102 of the inner tube 10 and the polygonal hole 105 and abuts against another end of the spring 30, and the upper toothed block 40 is shaped as a polygonal body corresponding to the polygonal hole 105 of the inner tube 10. The lower toothed block 50 has a polygonal through hole 5 at a center position and a plurality of tooth slots 52 and a plurality of teeth 53 alternatingly at one end, the lower toothed block 50 is disposed in the containing space 102 of the inner tube 10, and the lower toothed block 50 and the upper toothed block 40 are engaged via the balls 60. The central axis 70 has a driving hole 71 with polygonal shape and is placed through the polygonal through hole 51 of the lower toothed block 50 and the through hole 41 of the upper toothed block 40 and the central axis 70 is sandwiched between the adjusting unit 80 and the lower toothed block 50 via the adjusting unit. The central axis 70 has a polygonal portion 72 corresponding to the polygonal through hole 50. With the engagement of the polygonal portion 72 and the polygonal through hole 51, the external tool wrench A inserted from the through aperture 22 further enters into the driving hole 71, such that the lower toothed block 50 and the central axis 70 all move simultaneously, as shown in FIG. 5 and FIG. 6. The adjusting unit 80 has a positioning ring 81, a compressing member 82 and a stopping ring 83. The positioning ring 81 has at least one screw hole 811 for accepting a screw in the containing space 102 to limiting the positioning ring 81 in the containing space 102. The compressing member 82 and the stopping ring 83 respectively have a first outer threaded section 821 and a second outer threaded section 831 such that the compressing member 82 engages with the first outer threaded section 821 via the first inner threaded section 103, the stopping ring 83 engages with the second inner threaded section 831 via the second outer threaded section 104, and the compressing member 82 has a polygonal hole 822.

Furthermore, the inner tube 10 has two sliding slots 106, and the positioning ring 81 has two screw holes 811.

Also, one of the sliding slots 106 has a screw 11, and another sliding slot has 106 a screw 11 and an elastic plate. 12.

Furthermore, the polygonal hole 105 and the upper toothed block 40, the polygonal through hole 51 and the polygonal portion 72 respectively have matching hexagonal shapes.

Additionally, the driving hole 71 and the polygonal hole 822 both have hexagonal shapes.

Again, one sidewall of each tooth slot 52 is a vertical side and another side is an inclined side.

Moreover, a top end of each tooth 53 has a groove 531 for positioning the ball 60 to prevent the ball 60 from escaping between the lower toothed block 50 and the upper toothed block 40, and the groove 531 connects the tooth slots 52 at both sides of the teeth 53.

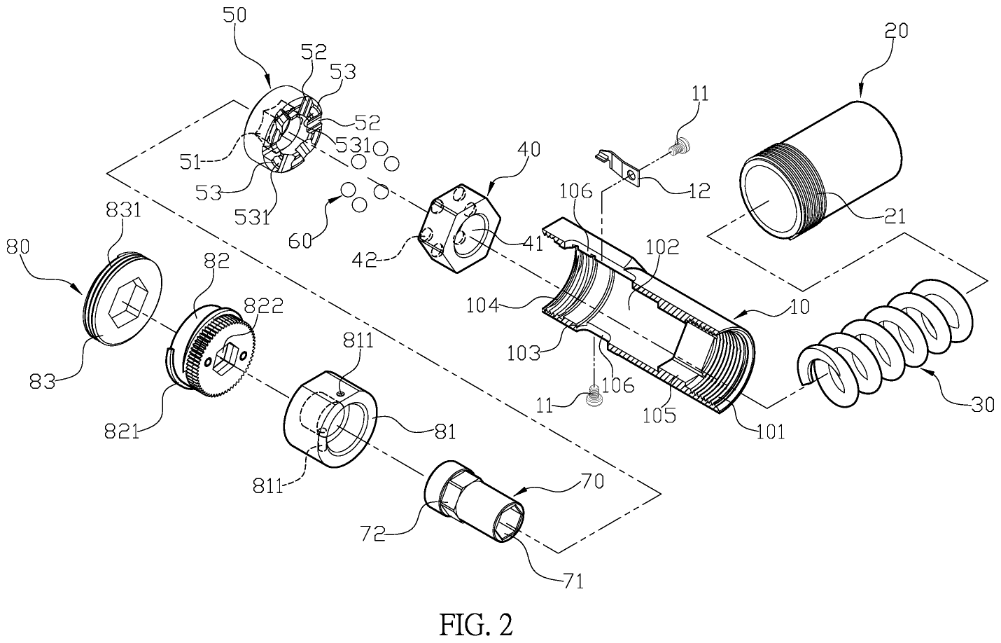

Also, the lower toothed block are separate parts as shown in FIG. 2.

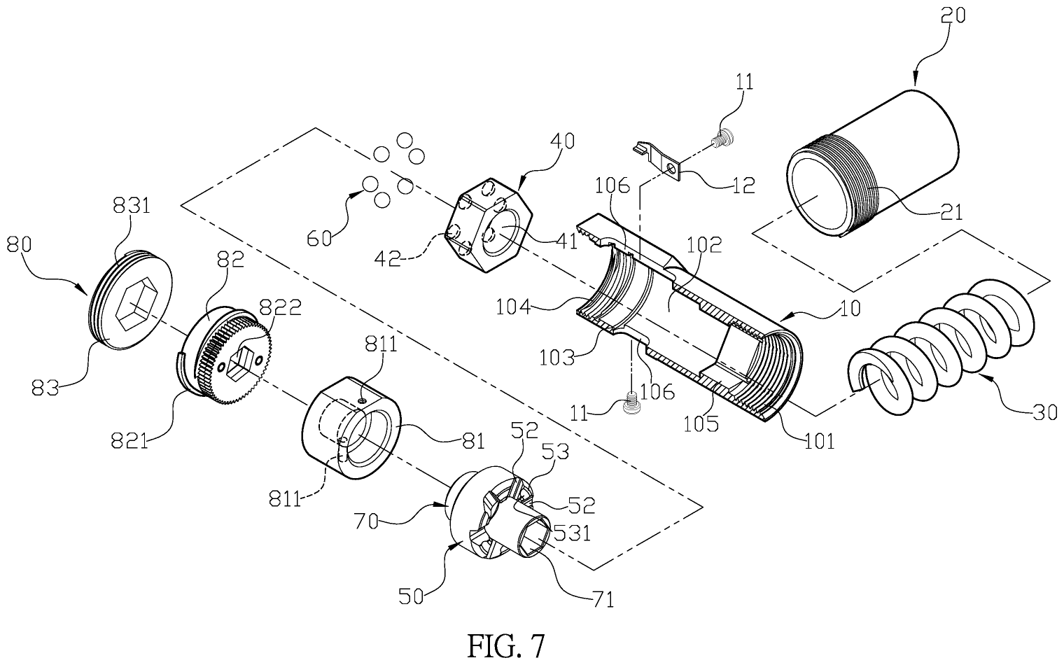

Additionally, the lower toothed block 50 and the central axis 70 are integrally formed as shown in FIG. 7.

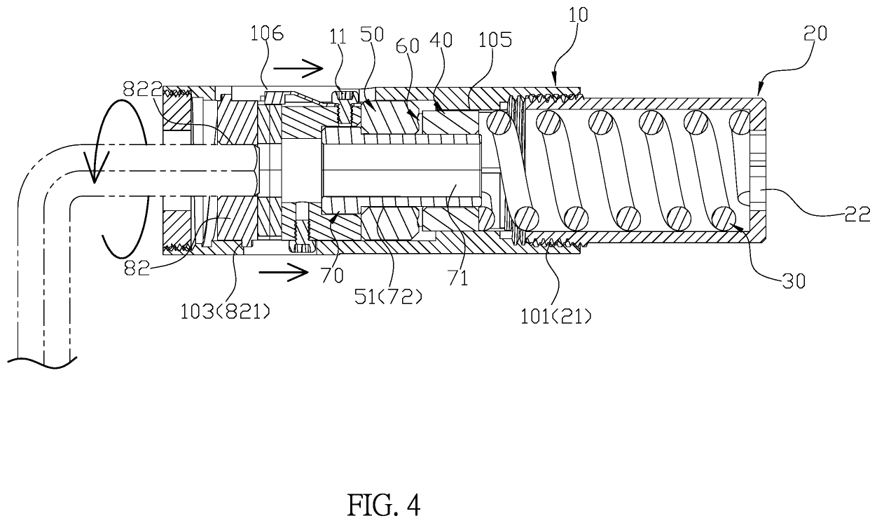

In actually operation, a polygonal wrench tool is inserted into the polygonal hole 822 of the compressing member 82 from the stopping ring 83 and rotated, as shown in FIG. 4, so that with the engagement of the outer threaded section 821 and the first inner threaded section 103, the compressing member 82 is able to be rotated inwardly or outwardly in the inner tube 10. When the pre-set torque value is higher, the compressing member 82 is rotated inward and pushes the positioning ring 81 to move, the positioning ring 81 then pushes the lower toothed block 50 closer to the upper toothed block 40, and the upper toothed block 40 is pushed by the elasticity of the spring 30, so that the lower toothed block 50 and the upper toothed block 40 is more tightly locked with each other through the balls 60, which generates larger torque value. When the pre-set torque value is lower, the compressing member 82 is moved outwardly, the positioning ring 81, the lower toothed block 50 and the upper toothed block 40 are elastically pushed by the spring 30 and move outwardly. At this time, the lower toothed block 50 and the upper toothed block 40 are less tightly locked, and generated torque value is lower. When driving the tool wrench A to rotate, as shown in FIG. 5, if the applied force exceeds the pre-set torque value, the balls 60 will be brought out of the tooth slot 52 to form an idling phenomenon, which allows the tooth slot 52 to rotate. The lower toothed block 50 and the upper toothed block 40 cannot be locked by the balls 60, so the overload protection effect can be provided, as shown in FIG. 6.

The above-mentioned torque adjustment tool has the following advantages: the outer circumferential arc surface of the steel 60 has a larger stress-bearing area relative to the inclined surface, so when the upper toothed block 40 and the lower toothed block 50 are locked by the balls 60 and it makes the transmission more reliable. Furthermore, with the rolling of the balls 60, the friction resistance can be greatly reduced, which makes it easier for the steel ball 60 to be taken out of the tooth slot 52 for high overload protection sensitivity.

Although the present invention has been explained in relation to its preferred embodiment, it is to be understood that many other possible modifications and variations can be made without departing from the spirit and scope of invention as hereinafter claimed.

What is claimed is:

1. A torque adjustment tool comprising: an inner tube, a front tuning handle, a spring, an upper toothed block, a lower toothed block, a plurality of balls, a central axis, and an adjusting unit; wherein:
the inner tube has an inner screw hole at one end and a containing space at another end, a first inner threaded section and a second inner threaded section are provided on a sidewall of the containing space, a polygonal hole provided between the containing space and the inner screw hole, and a sidewall of the inner tube having at least one sliding slot passing through the containing space and having at least one screw;
the front tuning handle has an open end and a closed end, the open end has an outer threaded section on an outer surface for engaging with the inner screw hole of the inner tube, the closed end has a through aperture for accepting an external tool wrench for insertion into the inner tube;
the spring is disposed in the inner tube, an end of the spring abutting the closed end of the front tuning handle;
the upper toothed block has a through hole surrounded by a plurality of ball slots, the upper toothed block disposed in the containing space of the inner tube and the polygonal hole and abutting against another end of the spring, the upper toothed block shaped as a polygonal body corresponding to the polygonal hole of the inner tube;
the lower toothed block has a polygonal through hole at a center position and a plurality of tooth slots and a plurality of teeth alternatingly at one end, the lower toothed block disposed in the containing space of the inner tube, and the lower toothed block and the upper toothed block are engaged via the balls;
the central axis has a driving hole with polygonal shape and is placed through the polygonal through hole of the lower toothed block and the through hole of the upper toothed block; wherein the central axis is sandwiched between the adjusting unit and the lower toothed block; the central axis has a polygonal portion corresponding to the polygonal through hole; with the engagement of the polygonal portion and the polygonal through hole, the external tool wrench inserted from the through aperture further enters into the driving hole, such that the lower toothed block and the central axis all move simultaneously; and
the adjusting unit has a positioning ring, a compressing member and a stopping ring, the positioning ring has at least one screw hole for accepting a screw in the containing space; the compressing member and the stopping ring respectively have a first outer threaded section and a second outer threaded section such that the compressing member engages with the first outer threaded section via the first inner threaded section, the stopping ring engages with the second inner threaded section via the second outer threaded section, and the compressing member has a polygonal hole.

2. The torque adjustment tool as claimed in claim 1, wherein the inner tube has two sliding slots, and the positioning ring has two screw holes.

3. The torque adjustment tool as claimed in claim 1, wherein the inner tube has two sliding slots, the positioning ring has two screw holes, one of the sliding slots has a screw, and another sliding slot has a screw and an elastic plate.

4. The torque adjustment tool as claimed in claim 1, wherein the polygonal hole and the upper toothed block, the polygonal through hole, and the polygonal portion respectively have matching hexagonal shapes.

5. The torque adjustment tool as claimed in claim 1, wherein the driving hole and the polygonal hole both have hexagonal shapes.

6. The torque adjustment tool as claimed in claim 1, wherein one sidewall of each tooth slot is a vertical side and another side is an inclined side.

7. The torque adjustment tool as claimed in claim 1, wherein a top end of each tooth has a groove for positioning the ball to prevent the ball from escaping between the lower toothed block and the upper toothed block, and the groove connects the tooth slots at both sides of the teeth.

8. The torque adjustment tool as claimed in claim 1, wherein the lower toothed block and the central axis are separate parts.

9. The torque adjustment tool as claimed in claim 1, wherein the lower toothed block and the central axis are integrally formed.
